(19) United States
(12) Patent Application Publication
(10) Pub. No.: US 2019/0164202 A1
(43) Pub. Date: May 30, 2019

(54) SYSTEM AND METHOD FOR REAL TIME ARTIFICIAL INTELLIGENCE BASED PRICE DETERMINATION

(71) Applicants: Sanjeev Sadanand Ukhalkar, Fremont, CA (US); Cem Yildirim, Fremont, CA (US)

(72) Inventors: Sanjeev Sadanand Ukhalkar, Fremont, CA (US); Cem Yildirim, Fremont, CA (US)

(21) Appl. No.: 15/824,620

(22) Filed: Nov. 28, 2017

(51) Int. Cl. G06Q 30/02; G06N 99/00

(52) U.S. Cl. CPC G06Q 30/0283; G06N 99/005

(57) ABSTRACT

System and method for real time artificial intelligence based price determination are provided. An optimal sales price for an item on sale by a vendor is determined. The system determines a set of customer mobile device located inside an offer coverage area (OCA) of the vendor. Each customer mobile device of the set of customer mobile device has a mobile application installed therein. The system further determines a target customer list from the set of customer mobile device. The system refines the target customer list based on price, distance and other parameters defined in customer profiles. The system generates an optimal sales price for the item and makes price recommendations based on multiple multiplication factors. The system sends the offer recommendations to the set of refined target customer list.

### BACKGROUND

### Field of the Invention

The present invention relates generally to pricing products and services, and more particularly to methods and systems for dynamically making pricing recommendations for the products and services based on customer preferences.

### Description of the Related Art

With the advent of internet and smartphones, e-commerce has developed rapidly. E-commerce is one of the easiest and most convenient channels for vendors and service providers to conduct their businesses. Typically, the vendors may sell their products to customers at a brick and mortar location/shop, through a website, or a combination of both aforementioned channels. E-commerce makes the process of buying the products and services, available in the market, smooth and hassle-free. Further, e-commerce offers access to wide variety information about the products and services to the customers almost immediately. Additionally, e-commerce websites and mobile applications provide wide variety of options and alternatives from which the customers may choose their desired product.

To increase sales for a particular product, vendors and service providers typically introduce discounts or offers for buyers. Using discounts and offers can be advantageous for a vendor to overcome competition from other vendors. The customers rely on discounts and offers to reduce expenditure on purchased products and services. Generally, vendors notify the customers regarding discounts and offers beforehand by way of newspapers, internet advertisements, mobile applications, and media outlets and the like. Further, customers are also notified about the discounts and offers through emails and short message services (SMSs). The customers usually dislike constant receipt of emails and notifications, as they are distracting and disturbing.

Further, the vendors do not take into account preferences and interests of their customers while generating the discounts and offers. The vendors typically send discount and offer notifications to the customers for all the products and services that are up for sale. Further, the vendors generate offers for all the customers irrespective of the location of the customers. Hence, all the customers get the notification of the offers and discounts. The aforementioned method is thus inefficient and leads to wastage of cellular and Internet bandwidth. The vendors send notifications of offers and discounts to the customers to increase their reputation and customer count. Sending notifications of the offers and discounts to all the customers does not ensure that all the customers will be interested in the offers and also degrades sales of the vendors.

Typically, the offers generated for the customers have a fixed discount rate. The offers do not take into account the sales of the product corresponding to the offer, and the number of customers near a vendor business location at the time of the offer. This is disadvantageous as the sale of the product based on the offer may be sub-optimal, and may cause losses to the vendor.

In light of the foregoing, there is a need for a method for generating offers and discounts for the products and services that overcome the aforementioned shortcomings.

### SUMMARY

In one embodiment, the present invention provides a method for generating an optimal offer price recommendation for an item, such as, for example a product or a service. A first set of customer locations corresponding to a first set of customer mobile devices is determined. Each customer mobile device of the first set of customer mobile devices includes a mobile application. A set of offer coverage areas corresponding to a first set of vendor business locations is determined. The set of offer coverage areas is determined based on an offer coverage perimeter value and a set of offer notification perimeter values. The offer coverage perimeter value corresponds to a vendor and the set of offer notification perimeter values corresponds to the first set of customer mobile devices. A first subset of customer mobile devices is identified from the first set of customer mobile devices based on at least one of the set of offer coverage areas, a vendor business location, and the first set of customer locations. Further, a second subset of customer mobile devices is identified from the first subset of customer mobile devices based on the set of offer notification perimeter values. An optimal sales price for the item is determined based on at least one of customer profiles, vendor profiles, and the second subset of customer mobile devices. The customer and vendor profiles are stored in customer and vendor databases, respectively. An offer accessible through the mobile application for the item is generated for the second subset of customer mobile devices.

In another embodiment, the present invention provides a system for optimizing a sales price for an item, such as, for example a product or a service. The system includes a memory for storing customer profile, customer location, and vendor profile databases. The system further includes a server communicatively coupled with the memory. The server determines a first set of customer locations corresponding to a first set of customer mobile devices. Each customer mobile device of the first set of customer mobile devices includes a mobile application. A set of offer coverage areas corresponding to a first set of vendor business locations is determined. The set of offer coverage areas is determined based on an offer coverage perimeter value and a set of offer notification perimeter values. The offer coverage perimeter value corresponds to a vendor and the set of offer notification perimeter values corresponds to the first set of customer mobile devices. A first subset of customer mobile devices is identified from the first set of customer mobile devices based on at least one of the set of offer coverage areas, a vendor business location, and the first set of customer locations. Further, a second subset of customer mobile devices is identified from the first subset of customer mobile devices based on the set of offer notification perimeter values. An optimal sales price for the item is determined based on at least one of customer profiles, vendor profiles, and the second subset of customer mobile devices. The customer and vendor profiles are stored in customer and vendor databases, respectively. An offer accessible through the mobile application for the item is generated for the second subset of customer mobile devices.

### BRIEF DESCRIPTION OF THE DRAWINGS

The various features, aspects, and advantages of the present system and method are set forth with particularity in the appended claims. Embodiments of the present system and method will hereinafter be described in conjunction with the appended drawings provided to illustrate, and not to limit, the scope of the claims, wherein like designations denote like elements, and in which:

FIGS. 1A-B are flowcharts illustrating an exemplary method for generating recommendations of an optimized sales price for an item, in accordance with an embodiment of the present invention;

FIG. 2 is a flowchart illustrating an exemplary method for determining a radius of an offer coverage area for a vendor, in accordance with an embodiment of the present invention;

FIG. 3 is a flowchart illustrating an exemplary method for generating a target customer list, in in accordance with an embodiment of the present invention;

FIG. 4 illustrates a schematic block diagram of an exemplary system for generating recommendations for an optimized sales price of an item, in accordance with an embodiment of the present invention; and

FIG. 5 is a block diagram illustrating system architecture of a computer system, in accordance with various embodiments of the present invention.

### DETAILED DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

It may be noted that the components and the method steps have been described in the present specification to show specific details that are pertinent for an understanding of the embodiments described herein. Furthermore, the various components and the method steps have been represented so as not to obscure the disclosure with details that will be readily apparent to those with ordinary skill in the art having the benefit of the description herein.

The exemplary method is illustrated as a collection of blocks in a logical flow chart, which represents operations that may be implemented in hardware, software, or combinations thereof. The various operations are depicted in the blocks to illustrate the functions that are performed during various phases of the exemplary method. In the context of software, the blocks represent computer instructions that, when executed by one or more processors, perform the recited operations. The order in which the exemplary method is described is not intended to be construed as a limitation, and any number of the described blocks may be combined in any order to implement the exemplary method disclosed herein, or an equivalent alternative method. Additionally, certain blocks may be deleted from the exemplary method or augmented by additional blocks with added functionality without departing from the spirit and scope of the subject matter described herein.

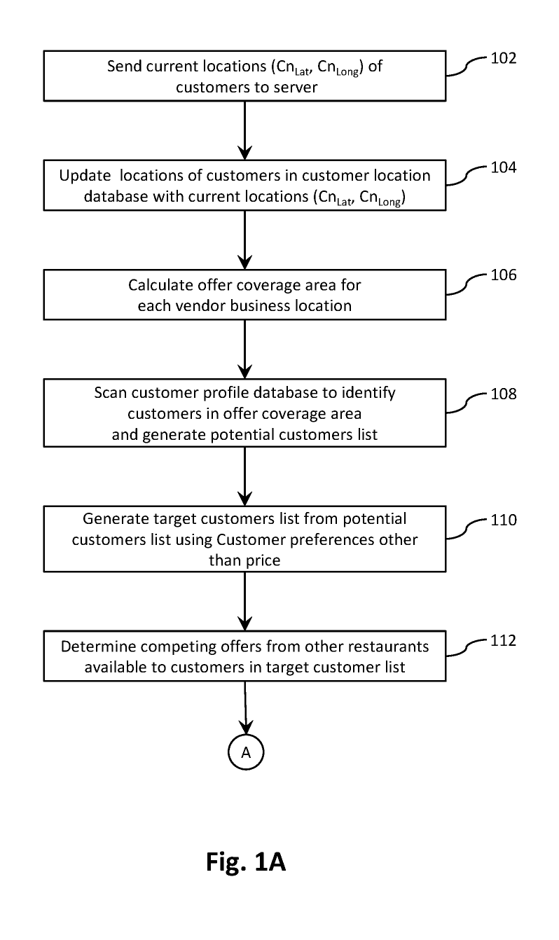

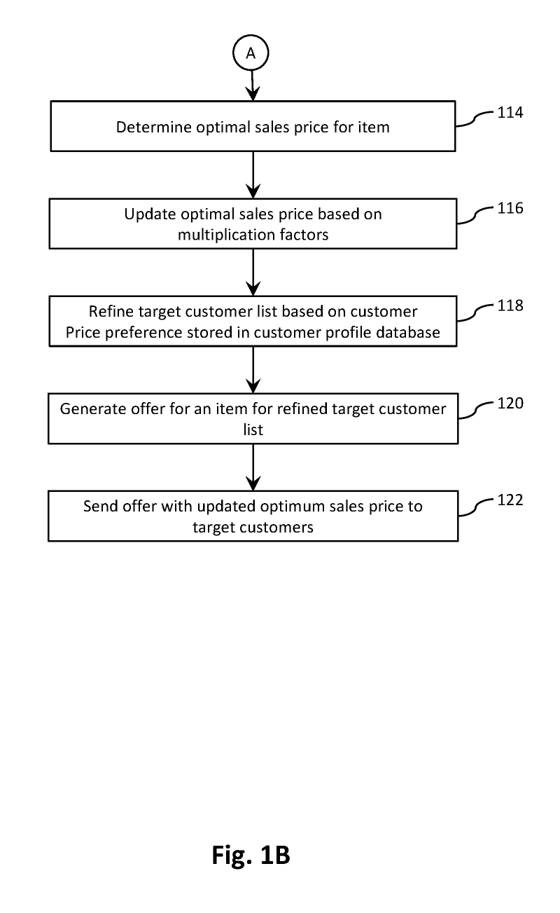

FIG. 1 illustrates a flowchart depicting an exemplary method for generating recommendations of an optimized sales price for an item (also referred to as products and services). A vendor having a vendor business location and a vendor mobile device sells the item to customers. The customers have a customer mobile device each. The customer mobile devices and the vendor mobile device each have a mobile application installed on them. It should be noted that while in the description, the terms vendor business location and vendor mobile device are interchangeably used, the vendor business location is constant, whereas the vendor mobile device is mobile in nature and may be at a different location than that of the vendor business location. For the sake of simplicity, it is assumed that the vendor mobile device is at the vendor business location. The invention is equally applicable in cases when the vendor mobile device is not at the vendor business location.

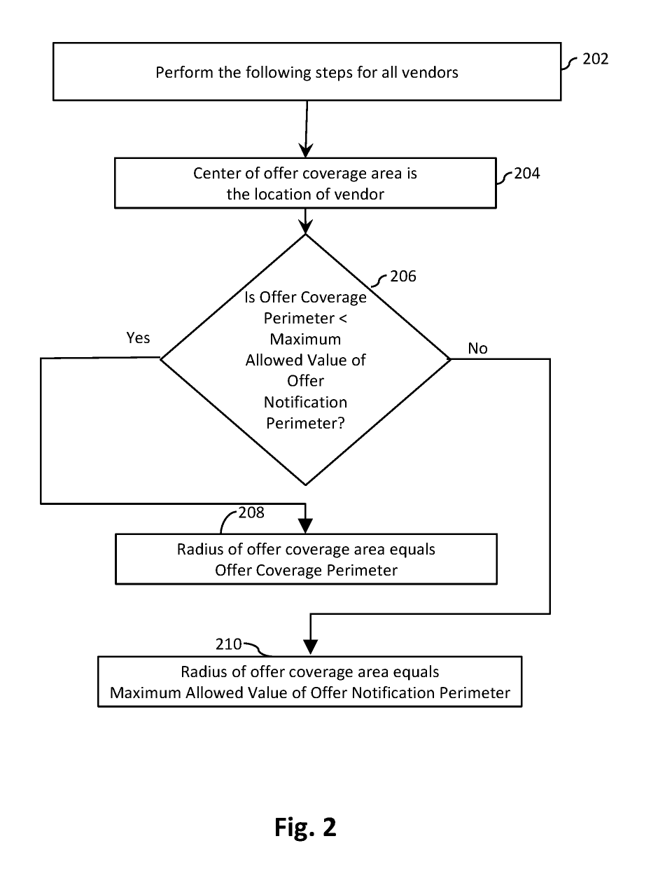

At step 102, locations of the customer mobile devices (Cₗₐₜ and C_{long}) are sent to a server. The server determines the location of the customer mobile devices by receiving a periodic message sent by each customer mobile device through a mobile application running thereon. At step 104, the server saves and updates the locations of the customer mobile devices (Cₗₐₜ and C_{long}) in a customer location database. At step 106, the server calculates offer coverage areas corresponding to a vendor business location, for each vendor that has the mobile application running on the corresponding vendor mobile device. The server calculates the offer coverage areas based on an offer coverage perimeter (OCP) value corresponding to the vendor, and a maximum allowed value for offer notification perimeter (ONP) value corresponding to the customer mobile devices. An exemplary methodology for calculating the offer coverage areas is described in detail with reference to FIG. 2.

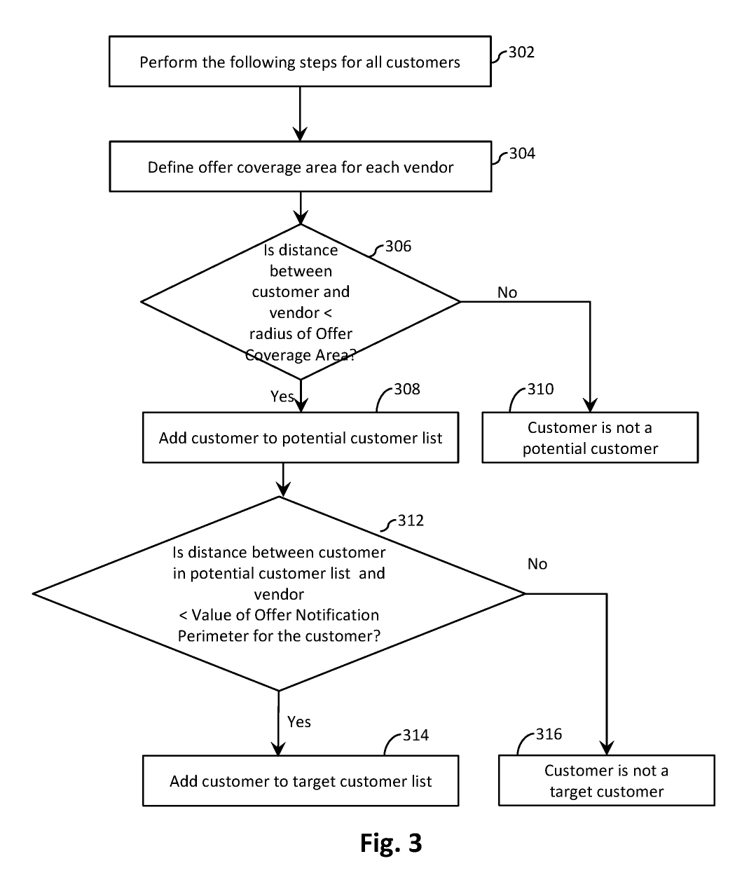

At step 108, the server scans through the customer location database, and generates a potential customer list. The customers that lie within the vendor's corresponding offer coverage areas are added to the potential customer list. At step 110, the potential customer list is further refined to generate a target customer list. The target list is further refined based on the customer preferences other than price preference that are stored in the customer profile database. An exemplary methodology for generating potential and target customer lists is described in detail with reference to FIG. 3.

At step 112, the server scans through the vendor database, and determines a number of competing offers made by other vendors to the customers in the vendor's offer coverage area. At step 114, an initial optimum sales price is determined for the item on sale. The server configures a machine learning algorithm for determining the initial optimum sales price. The machine learning algorithm determines the initial optimum price based on at least the available number of items for sale and historical averages for number of items sold for different offer prices in the vendor's coverage area during that day of the week and time of the day. The machine learning algorithm also maintains the historical averages for number of competing offers in the vendor's offer coverage area, number of total customers in vendor's offer coverage area, and number of targeted customers in the vendor's coverage area. These historical averages are maintained for each hour of the day and day of the week. At step 116, the server updates the initial optimum sales price based on three multiplication factors. The three multiplication factors are determined as follows:

Multiplication Factor 1=(Average number of competing offers from historical data/current number of competing offers)

Multiplication Factor 2=(Current number of all customers/Average number of all customers from historical data)

Multiplication Factor 3=(Current number of targeted customers/Average number of targeted customers from historical data)

The optimum sales price is determined as follows:

Updated optimum sales price=Initial optimum sales price*Multiplication Factor 1*Multiplication Factor 2*Multiplication Factor 3

Further, at step 118, the target customer list is refined based on the price preferences of the customers stored in the customer profile database. The customer profile database provides the price preferences of the customer that include an offer price range corresponding to a customer. The offer price offer price range is indicative of a price of the item that a particular customer is willing to pay.

At step 120, the server generates the offer for the customers of the target customer list based on the updated optimum sales price. At step 122, the offer is either presented to the customers of the target customer list for accessing by way of the mobile application installed in their respective customer mobile devices, or an offer recommendation can be made to the vendor for updating the offer by the vendor. The vendor may decide to change the sales price based on the recommendation made by the server of the present invention.

FIG. 2 illustrates a flowchart for depicting an exemplary method for determining offer coverage areas corresponding to a vendor. An offer coverage area is a circular area surrounding the vendor's business location. At step 204, the center of vendor's offer coverage area is determined to be the physical location of the vendor's business (Vₗₐₜ, V_{long}) obtained from the vendor's profile database. At step 206, the offer coverage perimeter value from vendor's profile is compared with the maximum allowable offer notification perimeter value for customer mobile devices. At step 208, if the offer coverage perimeter value of the vendor is less than the maximum allowed offer notification perimeter value of a customer mobile devices, then a radius of a corresponding offer coverage area is determined to be equal to the offer coverage perimeter value of the vendor. At step 210, if the offer coverage perimeter value of the vendor is more than the maximum allowed offer notification perimeter value of a customer mobile devices, then radius of the corresponding offer coverage area is determined to be equal to the maximum allowed value of offer notification perimeter of the mobile customer device.

FIG. 3 is a flowchart illustrating an exemplary method for generating the potential customer list and target customer list, in accordance with an embodiment of the present invention. To that end, step 302, a series of steps 304 to 316 are executed for each customer mobile device to generate the target customer list. At step 304, an offer coverage area is determined for a vendor, as illustrated in FIG. 2. At step 306, it is determined if a distance between the customer mobile device and the vendor business location is less than a radius of the corresponding offer coverage area. At step 306, if it is determined that the distance between the customer mobile device and the vendor business location is less than the radius of the corresponding offer coverage area, then step 308 is executed. At step 308, the customer having the customer mobile device is added to the potential customer list. At step 306, if it is determined that the distance between the customer mobile device and the vendor business location is greater than the radius of the corresponding offer coverage area, then step 310 is executed. At step 310, it is determined that the customer having the customer mobile device is not a potential customer, and is not added to the potential customer list for this vendor.

For a customer in the potential customer list, it is determined at step 312 if the distance between the location of the corresponding customer mobile device and the location of the vendor's business is less than the offer notification perimeter value corresponding to the customer. If the distance between the location of the customer mobile device and the location of the vendor's business is less than the offer notification perimeter value corresponding to the customer, step 314 is executed. At step 314, the customer is added to the target customer list. If the distance between the location of the customer mobile device and the location of the vendor's business is greater than the offer notification perimeter value corresponding to the customer, step 316 is executed. At step 316, it is determined that the customer is not a target customer, and is not added to the target customer list.

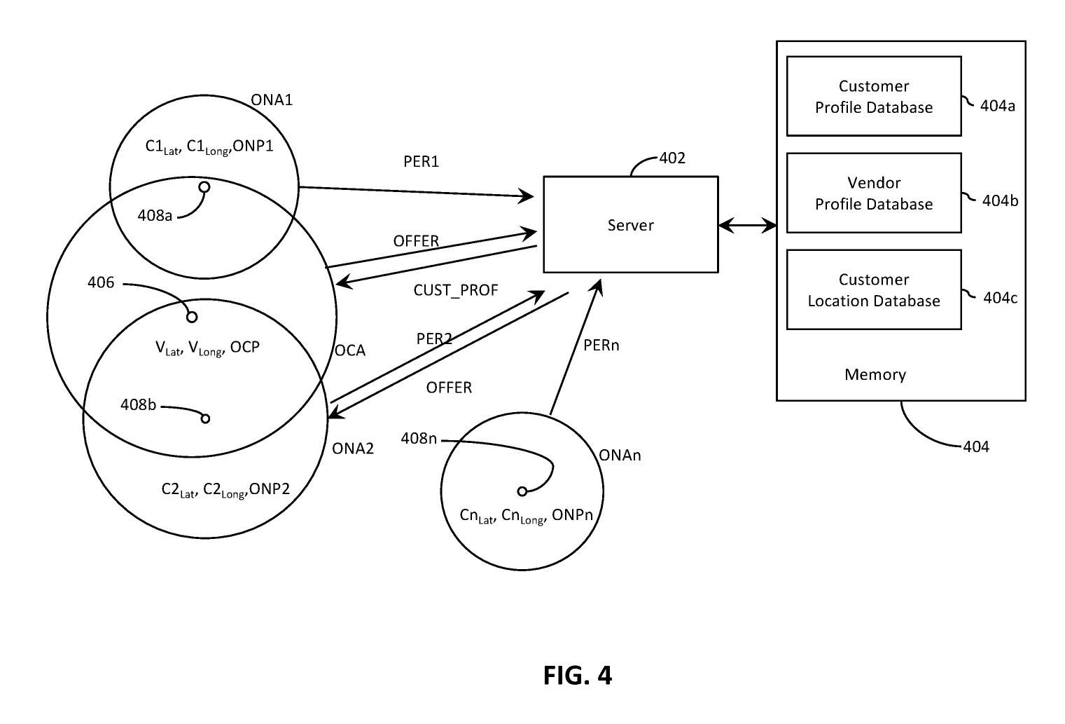

FIG. 4 illustrates a schematic block diagram of a system for optimizing the sales price of an item, in accordance with an embodiment of the present invention. The sales price optimization system 400 includes a server 402, a storage module 404, a vendor device 406, and customer mobile devices 408a-408n. A mobile application is installed on the vendor device 406, and the customer mobile devices 408a-408n. The server 402 determines current locations (C1_{Lat}, C1_{Long})−(Cn_{Lat}, Cn_{Long}) corresponding to the customer mobile devices 408a-408n. The customer mobile devices 408a-408n send periodic signals PER1-PERn each, to the server 402. The server 402 subsequently determines the current locations (C1_{Lat}, C1_{Long})−(Cn_{Lat}, Cn_{Long}) of the multiple mobile devices based on the periodic signals PER1-PERn. In one instance, the customer mobile device 408a sends the periodic signal PER1 to the server 402. The server 402 determines the location (C1_{Lat}, C1_{Long}) of the customer mobile device 408a based on the periodic signal PER1. The current locations (C1_{Lat}, C1_{Long})−(Cn_{Lat}, Cn_{Long}) are then transmitted to the memory 404. The current locations (C1_{Lat}, C_{Long})−(Cn_{Lat}, Cn_{Long}) are subsequently stored in the customer location database 404c.

The vendor business location (V_{Lat}, V_{Long}) is stored in the vendor profile database 404b. The vendor profile database 404b is stored in the memory 404. An offer coverage perimeter value OCP is associated with the vendor 406. Offer notification perimeter values ONP1-ONPn are associated with the customer mobile devices 408a-408n. The server 402 determines offer notification areas for each of the customer mobile devices 408a-408n. The server 402 determines centers of the offer coverage areas at the vendor business location (V_{Lat}, V_{Long}). Further, based on the offer coverage perimeter value OCP and the offer notification perimeter values ONP1-ONPn, the server 402 retrieves the customer locations (C1_{Lat}, C1_{Long})−(Cn_{Lat}, Cn_{Long}) from the customer location database 404b, and generates a potential customer list based on the customer locations (C1_{Lat}, C1_{Long})−(Cn_{Lat}, Cn_{Long}). Further, the server 402 generates the target customer list based on the offer notification values ONP1-ONPn. The server 402 subsequently retrieves the customer profile database 404a from the memory.

Further, based on the customer profile database 404a, the server 402 refines the target customer list to generate a refined target customer list. The server 402 then implements an artificial intelligence algorithm for determining the optimal sales price for the item. The server 402 determines competing offers for the item from other vendors for the customers in the potential customers list. The server 402 subsequently determines the initial optimal sales price for the item based on historical data. The server 402 then updates the optimal sales price based on the multiplication factors. The server 402 then generates an offer OFFER for the customer mobile devices from the refined target list. The server 402 subsequently sends the offer OFFER to customers in the refined target customer list based on the updated optimal sales price. The offer OFFER can be accessed by the customers in the refined target customer list by way of the mobile application.

The sales price optimization system 400 facilitates the implementation of the method for optimization of the sales price of the item and further reduces the cost involved. Since the sales price optimization system 400 is implemented through a mobile application, the need for a brick and mortar location is eliminated. Further, since the server 402 implements the artificial intelligence algorithm, the offer OFFER is sent only to customers included in the refined target customer list. This is advantageous as it saves the customers from the hassle of receiving constant emails and notifications regarding the offer OFFER. Sending the offer OFFER to all the customers causes unnecessary wastage of internet bandwidth. This further increases the cost of operations for the vendor. The sales price optimization system 400 overcomes the aforementioned wastage of internet bandwidth as well as saves the cost of operations for the vendor by sending the offer OFFER only to the customers included in the refined target customer list, as these are the customers that are most likely to avail the offer.

Further, implementation of the artificial intelligence algorithm facilitates the vendor to modify the offer OFFER in real time based on the customer and vendor profile databases 404a and 404b. Ability to modify the offer OFFER in real time enables the vendor to increase sales, while further increasing the probability of a customer buying the item. Since the offer OFFER is sent to any customer based on the liking of the customer, it aids in increasing the sales, while helping the vendor to maintain his clientele. Further, the implementation of the artificial intelligence algorithm also enables the vendor to apply further analytical tools to determine the choice of the customers, and modify the item accordingly.

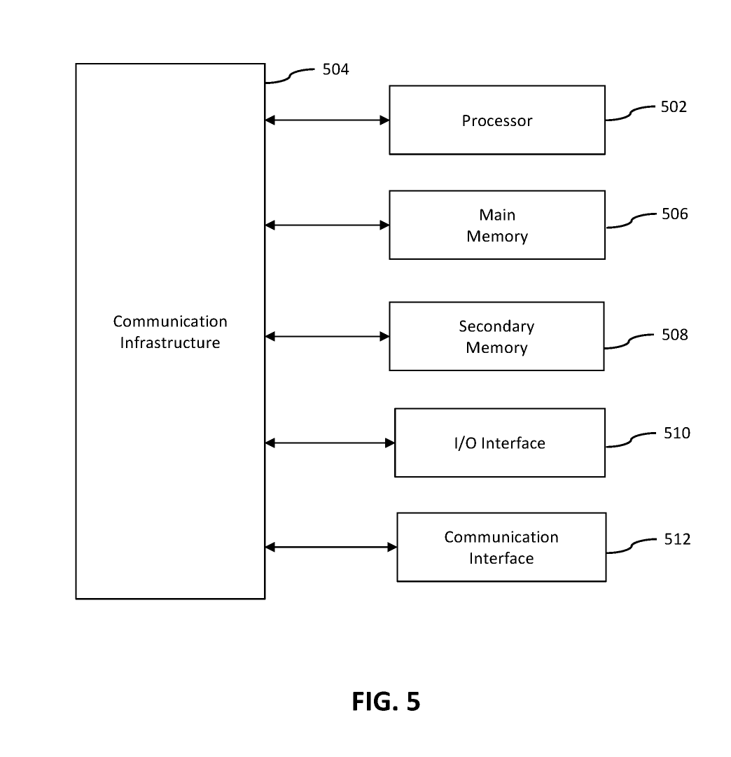

Referring now to FIG. 5, a block diagram that illustrates system architecture of a computer system 500, in accordance with an embodiment of the present invention, is shown. An embodiment of present invention, or portions thereof, may be implemented as computer readable code on the computer system 500. In one example, the server 402, the customer mobile devices 406a-406n, and the vendor mobile device 408 of FIG. 4 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIG. 1, FIG. 2, and FIG. 3.

The computer system 500 includes a processor 502 that may be a special purpose or a general-purpose processing device. The processor 502 may be a single processor, multiple processors, or combinations thereof. The processor 502 may have one or more processor “cores.” In one example, the processor 502 is an octa-core processor. Further, the processor 502 may be connected to a communication infrastructure 504, such as a bus, message queue, multi-core message-passing scheme, and the like. The computer system 500 further includes a main memory 506 and a secondary memory 508. Examples of the main memory 506 may include RAM, ROM, dynamic RAM (DRAM), and the like. The secondary memory 508 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 500 further includes an input/output (I/O) interface 510 and a communication interface 512. The I/O interface 510 includes various input and output devices that are configured to communicate with the processor 502. Examples of the input devices may include a keyboard, a mouse, a joystick, a touchscreen, a microphone, and the like. Examples, of the output devices may include a display screen, a speaker, headphones, and the like. The communication interface 512 may allow data to be transferred between the computer system 500 and various devices that are communicatively coupled to the computer system 500. Exemplary communication interfaces 512 may include a modem, a network interface, i.e., an Ethernet card, a communications port, and the like. Data transferred via the communication interface 512 corresponds to signals, such as electronic, electromagnetic, optical, or other signals as will be apparent to a person skilled in the art. The signals may travel via a communications channel (not shown) which transmits the signals to devices that are communicatively coupled to the computer system 500. Examples of the communications channel include, but are not limited to, cable, fiber optics, a phone line, a cellular phone link, or a radio frequency link.

Computer program medium and computer usable medium may refer to a non-transitory computer readable medium, such as the main memory 506 and the secondary memory 508, which may be a semiconductor memory such as a DRAM. The computer program medium may provide data that enables the computer system 500 to implement the methods illustrated in FIG. 1, FIG. 2, and FIG. 3. In an embodiment, the present invention is implemented using a computer implemented application, the computer implemented application may be stored in a computer program product and loaded into the computer system 500 using the removable storage drive or the hard disc drive in the secondary memory 508, the I/O interface 510, or the communication interface 512.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 502 and a memory such as the main memory 506 and the secondary memory 508 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for generating optimal price recommendations for products and services using machine learning, artificial intelligence, and data analytics. While various exemplary embodiments of the disclosed system and method have been described above it should be understood that they have been presented for purposes of example only, not limitations. It is not exhaustive and does not limit the invention to the precise form disclosed.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for generating an optimal offer price recommendation for an item, the method comprising:
determining a first set of customer locations corresponding to a first set of customer mobile devices, wherein each customer mobile device of the first set of customer mobile devices includes a mobile application;
determining a set of offer coverage areas corresponding to a first set of vendor business locations, wherein the set of offer coverage areas is determined based on an offer coverage perimeter value and a set of offer notification perimeter values, and wherein the offer coverage perimeter value corresponds to a vendor and the set of offer notification perimeter values corresponds to the first set of customer mobile devices;
identifying a first subset of customer mobile devices from the first set of customer mobile devices based on at least one of the set of offer coverage areas, a vendor business location, and the first set of customer locations;
identifying a second subset of customer mobile devices from the first subset of customer mobile devices based on the set of offer notification perimeter values;
determining an optimal sales price for the item based on at least one of customer profiles, vendor profiles, and the second subset of customer mobile devices, wherein the customer and vendor profiles are stored in customer and vendor databases, respectively; and
generating an offer accessible through the mobile application for the item, wherein the offer is generated for the second subset of customer mobile devices.

2. The method of claim 1, wherein the step of determining the first set of customer locations further includes transmitting a periodic message to a server by each customer mobile device of the first set of customer mobile devices, and wherein the first set of customer locations is stored in a customer location database.

3. The method of claim 1, wherein the set of offer coverage areas, the offer coverage perimeter, and the set of offer notification perimeters are circular areas, wherein the set of offer coverage areas and the offer coverage perimeter have centers at the vendor business locations, and wherein each offer notification perimeter of the set of offer notification perimeters has a center at a corresponding customer device location of the first set of customer locations.

4. The method of claim 3, wherein an offer coverage area for each vendor has a radius equal to the smaller of the offer coverage perimeter value for the vendor and maximum allowed value of offer notification perimeter corresponding to a customer mobile device of the first set of customer mobile devices.

5. The method of claim 4, wherein a distance between each customer mobile device of the first subset of customer mobile devices and the vendor business location is less than the corresponding offer notification perimeter value of the set of offer notification values.

6. The method of claim 1, wherein the step of determining the optimal sales price for the item further includes:
determining a set of offers available to the second subset of customer mobile devices, wherein the set of offers is generated by a plurality of vendors;
determining an intermediate sales price for the item based on the set of offers, and vendor profile databases; and
determining the optimal sales price for the item based on the intermediate sales price, and at least one multiplication factor.

7. The method of claim 6, wherein the at least one multiplication factor includes:
a first multiplication factor, wherein the first multiplication factor is a ratio of a total number of offers at present time of the set of offers and a historical average of number of offers;
a second multiplication factor, wherein the second multiplication factor is a ratio of a total number of customer mobile devices at the present time of the second subset of customer mobile devices and a historical average of number of target customer mobile devices; and
a third multiplication factor, wherein the third multiplication factor is a ratio of a total number of customer mobile devices at the present time of the first set of customer mobile devices and a historical average of number of total customer mobile devices, wherein the vendor profile database includes the average number of offers, the average number of target customer mobile devices, and the average number of target customer mobile devices.

8. The method of claim 1, wherein the first set of locations and the vendor business location are determined using Global Positioning Satellite (GPS) system.

9. A system for optimizing a sales price for an item, comprising:
a memory for storing customer profile, customer location, and vendor profile databases; and
a server, wherein the server is configured to:
determine a first set of customer locations corresponding to a first set of customer mobile devices, wherein each customer mobile device of the first set of customer mobile devices includes a mobile application;
determine a set of offer coverage areas corresponding to a first set of vendors, wherein the set of offer coverage areas is determined based on an offer coverage perimeter value and a set of offer notification perimeter values, and wherein the offer coverage perimeter value corresponds to a vendor device and the set of offer notification perimeter values corresponds to the first set of customer mobile devices;
identify a first subset of customer mobile devices from the first set of customer mobile devices based on at least one of the set of offer coverage areas, a vendor business location, and the first set of customer locations;
identify a second subset of customer mobile devices from the first subset of customer mobile devices based on the set of offer notification perimeter values;
determine an optimal sales price for the item based on at least one of customer profiles, vendor profiles, and the second subset of customer mobile devices, wherein the customer and vendor profiles are stored in customer and vendor databases, respectively; and
generate an offer accessible through the mobile application for the item, wherein the offer is generated for the second subset of customer mobile devices.

10. The system of claim 9, wherein the server is further configured to determine the first set of customer locations by receiving a periodic message transmitted by each customer mobile device of the first set of customer mobile devices, and wherein the first set of customer locations is stored in a customer location database.

11. The system of claim 9, wherein the set of offer coverage areas the offer coverage perimeter, and the set of offer notification perimeters are circular areas, wherein the set of offer coverage areas and the offer coverage perimeter have centers at the vendor business location, and wherein each offer notification perimeter of the set of offer notification perimeters has a center at the corresponding customer location of the first set of customer locations.

12. The system of claim 11, wherein an offer coverage area for each vendor business location has a radius equal to the smaller of the offer coverage perimeter value for the vendor and maximum allowed value of offer notification perimeter corresponding to a customer mobile device of the first set of customer mobile device.

13. The system of claim 12, wherein a distance between each customer mobile device of the first subset of customer mobile devices and the vendor business location is less than the corresponding offer notification perimeter value of the set of offer notification values.

14. The system of claim 9, wherein the server is further configured for determining the optimal sales price for the item by:
determining a set of offers available to the second subset of customer mobile devices, wherein the set of offers is generated by a plurality of vendors;
determining an intermediate sales price for the item based on the set of offers, and customer and vendor profile databases; and
determining the optimal sales price based on the intermediate sales price, and at least one multiplication factor.

15. The system of claim 9, wherein the at least one multiplication factor includes:
a first multiplication factor, wherein the first multiplication factor is a ratio of a total number of offers of the set of offers and an average number of offers;
a second multiplication factor, wherein the second multiplication factor is a ratio of a total number of customer mobile devices of the second subset of customer mobile devices and an average number of target customer mobile devices; and
a third multiplication factor, wherein the third multiplication factor is a ratio of a total number of customer mobile devices of the first set of customer mobile devices and an average number of total customer mobile devices, wherein the vendor profile database includes the average number of offers, the average number of target customer mobile devices, and the average number of target customer mobile devices.

16. The system of claim 9, wherein the server determines the first set of locations and the vendor business location using Global Positioning Satellite (GPS) system.
